(19) United States
(12) Patent Application Publication
(10) Pub. No.: US 2017/0328113 A1
(43) Pub. Date: Nov. 16, 2017

(54) Driving Device And Vehicle Window Lifter Comprising Same

(71) Applicant: Johnson Electric S.A., Murten (CH)

(72) Inventors: Yue LI, Hong Kong (CN); Chui You ZHOU, Shenzhen (CN); Xiao Ning ZHU, Shenzhen (CN); Yong Gang ZHANG, Shenzhen (CN); Yong WANG, Shenzhen (CN)

(21) Appl. No.: 15/584,736

(22) Filed: May 2, 2017

(30) Foreign Application Priority Data
May 16, 2016 (CN) 2016 1032 3449.0

(51) Int. Cl. E05F 15/43; F16H 1/16; F16H 55/14; F16H 55/22

(52) U.S. Cl. CPC E05F 15/431; F16H 55/22; F16H 1/16; F16H 55/14

(57) ABSTRACT

A driving device and a vehicle window lifter are disclosed. The driving device includes a motor and a gearbox. The motor includes a stator and a rotor. The gearbox includes a housing and a gear. The motor is mounted in the housing and includes a rotary shaft driving the gear. The housing supports the motor through a soft support structure. Two bearings are mounted in the housing at the same side of the stator for supporting and determining an orientation of the rotary shaft. Over-constraint to the rotary shaft is eliminated by reducing the number of the rigid support points between the rotary shaft and housing. The soft connection between the motor and housing can avoid or reduce motor vibrations transferred to the gearbox.

### CROSS REFERENCE TO RELATED APPLICATIONS

This non-provisional patent application claims priority under 35 U.S.C. §119(a) from Patent Application No. 201610323449.0 filed in The People's Republic of China on 16 May 2016.

### FIELD OF THE INVENTION

The present invention relates to a driving device, and in particular to a vehicle window lifter using the driving device.

### BACKGROUND OF THE INVENTION

A driving device usually includes a motor and a gearbox connected with the motor. An output end of a rotary shaft of the motor is provided with a worm for meshing with a gear in the gearbox. Typically, the rotary shaft is rigidly connected to a housing of the driving device through bearings at more than three locations, i.e. at two ends of the worm and at one end of the motor. As such, this results in too many rigid end cap points, and vibrations of the motor can be directly conducted to the gearbox, which would be detrimental to operation of the driving device and affect the lifespan of the driving device as well.

### SUMMARY OF THE INVENTION

Some features and advantages of the present invention are described in the following description, or are obvious from the description, or may be learned through practicing the present invention.

One aspect of the present invention provides a driving device comprising a motor and a gearbox driven by the motor. The motor comprises a stator and a rotor rotatably disposed in the stator. The rotor comprises a rotary shaft. The gearbox includes a housing in which the motor is mounted, and a gear mounted to the housing and driven by the rotary shaft of the motor, two first bearings mounted in the housing at the same side of the stator for supporting the rotary shaft but allowing the stator to swing relative to the housing.

Preferably, a portion of the rotary shaft extending into the gearbox is mounted with a worm, and the worm is disposed between the two first bearings.

Preferably, the housing end caps the motor through a soft end cap structure, and the soft end cap structure includes a resilient member sandwiched between the motor and the housing.

Preferably, an outer surface of the resilient member for contacting the housing is wave-shaped.

Preferably, the motor includes a stator and a rotor, and the resilient member wraps around an outer side of the stator.

Preferably, the motor includes a stator and a rotor. Two end caps are mounted respectively to two ends of the stator, and each of the end caps is mounted with a second bearing. The rotor includes the rotary shaft and a rotor main body fixed to the rotary shaft, and the rotary shaft is rotatably mounted to the stator through the second bearings.

Preferably, the stator comprises a stator core. The two end caps are mounted respectively to two axial ends of the stator core, and the soft end cap structure is a resilient member wrapping around an outer circumferential surface of the stator core.

Preferably, the resilient member wraps around the outer circumferential surface and at least part of an axial end face of the stator core.

Preferably, a portion of the resilient member for wrapping around the axial end face of the stator core is formed with a plurality of protrusions.

Preferably, the motor further comprises a connecting member that passes through the two end caps and the stator core along an axial direction of the motor.

Preferably, the stator core comprises a closed yoke, two first salient poles extending inwardly respectively from two opposed first inner surfaces of the yoke, and two second salient poles extending inwardly respectively from two opposed second inner surfaces of the yoke. Each first salient pole includes a winding portion for mounting of a stator winding, and neither of the second salient poles includes a winding portion. The two first salient poles have the same polarity.

Preferably, a first pole shoe extends from an inner end of each first salient pole toward two circumferential sides thereof, each second salient pole comprises a second pole shoe extending along circumferential directions of the rotor, and the first pole shoes and the second pole shoes are spaced from each other and cooperatively define a substantially cylindrical cavity for receiving the rotor.

Preferably, a positioning groove is formed at a circumferential center of an inner surface of each of the first pole shoes and second pole shoes.

Preferably, the motor is a single phase motor.

Preferably, the two first bearings are located at the same axial side of the motor such that the motor is suspended at one end of the rotary shaft near the first bearings and is therefore capable of slightly swinging relative to the housing.

Another aspect of the present invention provides a vehicle window lifter which includes a motor and a gearbox driven by the motor. The motor comprises a stator and a rotor rotatable relative to the stator. The rotor comprises a rotary shaft. The gearbox includes a housing in which the motor is mounted, and a gear mounted to the housing and driven by the rotary shaft of the motor. The rotary shaft is supported by the housing via two bearings which are located at the same axial side of the stator of the motor such that the motor is suspended at one end of the rotary shaft and the stator is therefore capable of slightly swinging relative to the housing.

Preferably, the motor is a single phase four-pole motor with only two windings.

In the driving device and the vehicle window lifter, the motor rotary shaft is connected to the housing via two bearings at one side of the stator of the motor, such that the motor is supported in the housing at only two rigid support points, which avoids over-constraint to the rotary shaft. The soft connection between the motor and the housing can prevent the vibrations of the motor from being transferred to the gearbox housing. In addition, when a single phase motor is used, if the rotor stops at locations near to the dead point position, the rotor is still capable of startup as when the stator winding is electrified, under the action of the electromagnetic force formed between the stator and rotor, the stator is capable of swinging relative to the housing and the rotor to increase the startup torque of the rotor.

By reading this disclosure, those skilled in the art can better understand the features and contents of the technical solutions.

### BRIEF DESCRIPTION OF THE DRAWINGS

In order to make advantages and implementation of the present invention become more apparent, embodiments of the present invention are described below in detail with reference to the drawings. Contents shown in the drawings are for the purposes of illustration only and should not be regarded as limiting. In the drawings:

FIG. 1 illustrates a driving device according to one embodiment of the present invention.

FIG. 2 is a sectional view of the driving device of FIG. 1.

FIG. 3 illustrates a motor of a driving device of FIG. 1.

FIG. 4 is a top view of a stator core and a rotor of the motor of FIG. 3.

FIG. 5 is an exploded view of the stator core of the motor of FIG. 3.

FIG. 6 illustrates a resilient member of the motor of FIG. 3.

### DETAILED DESCRIPTION OF THE PREFERRED EMBODIMENTS

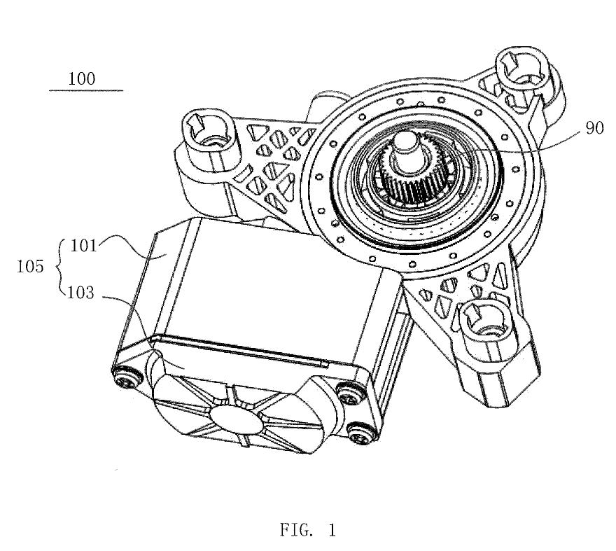

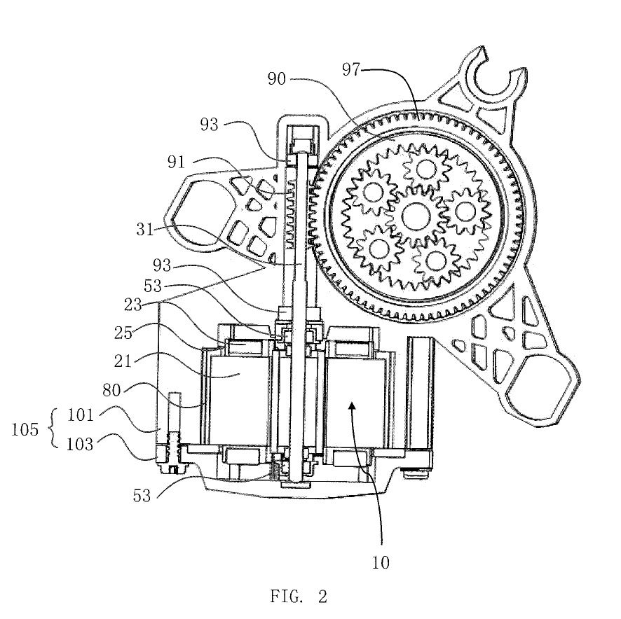

Referring to FIG. 1 and FIG. 2, a driving assembly 100 according to the present invention includes a motor 10 and a gearbox 90 for reducing the speed of the output of the motor 10. The gearbox 90 includes a housing 105, and the motor 10 is mounted within the housing 105. The housing 105 includes a main portion 101 and a bottom cap 103. Main components of the motor 10 and the gearbox 90 are located in the main portion 101. The motor includes a rotary shaft 31 extending into the gearbox 90. Two first bearings 93 are fixedly mounted to the housing 105 of the gearbox 90, for supporting the rotary shaft 31. The two first bearings 93 are rigidly mounted to the housing 105. Therefore, the two first bearings 93 may determine an orientation of the rotary shaft 31 and limit all degrees of freedom of the rotary shaft 31 except for rotation and axial displacement of the rotary shaft 31.

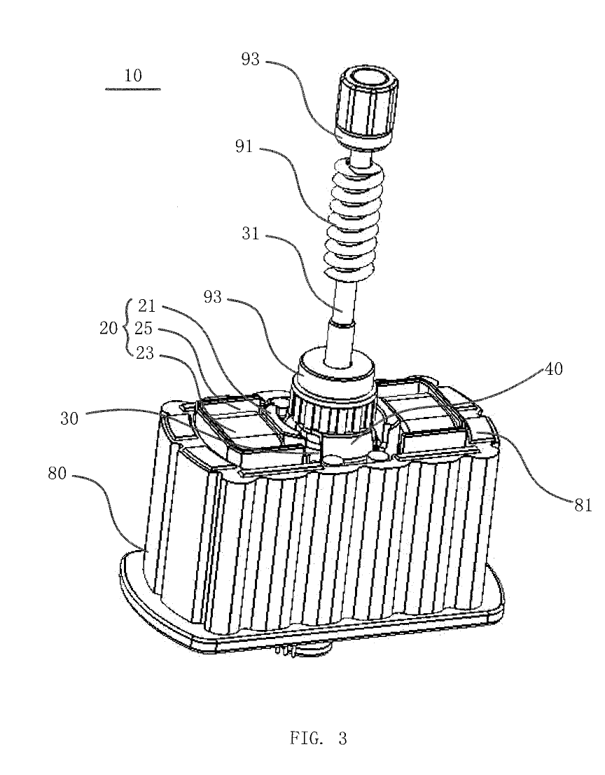

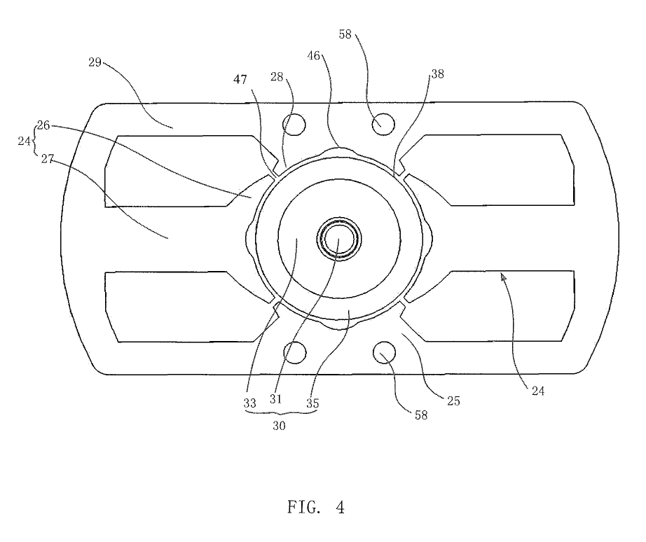

Referring to FIG. 3 and FIG. 4, the motor 10 includes a stator 20 and a rotor 30 rotatably mounted to the stator 20. The stator 20 includes a stator core 21, an insulation bracket 25 mounted to the stator core 21, and a stator winding 23 wound around the stator core 21 with the insulation bracket 25 located between the winding 23 and the stator core 21. The stator core 21 includes a yoke 29 that is substantially rectangular in shape, first salient poles/main salient poles 24 extending inwardly respectively from two opposed first inner surfaces of the yoke 29, and second salient poles/auxiliary salient poles 25 extending inwardly respectively from two opposed second inner surfaces of the yoke 29. Each first salient pole 24 includes a winding portion 27 for mounting of the stator winding 23, and a curved first pole shoe 26 extending from an axial inner end of the winding portion 27 toward two circumferential sides thereof. Each second salient pole 25 includes a neck portion which is expressly shorter than the winding portion 27 of the first salient pole 24. The second salient pole 25 includes a curved second pole shoe 28 extending from an axial inner end thereof toward two circumferential sides thereof. In this embodiment, the stator winding is wound only around the main salient poles 24. Upon energization, the two first salient poles 24 form magnetic poles having the same polarity, thereby causing the polarity of the second salient poles 22 to be opposite from the polarity of the first salient poles 24. Therefore, the first salient poles 24 and the second salient poles 22 cooperatively form four magnetic poles which cooperate with four permanent magnet poles of the rotor to form four magnetic circuits. In this embodiment, the yoke 29 is substantially rectangular in shape, which has two longer sides and two shorter sides. The two first salient poles 24 extend respectively from the two shorter sides, and the two second salient poles 22 extend respectively from the two longer sides. As such, the first salient poles 24 may be configured to have a greater length so as to allow a larger stator winding 23 to be wound thereon. It should be understood that the yoke of the stator core 20 is not limited to be in the rectangular shape; rather, it can be of another ring structure.

The first pole shoes 26 and the second pole shoes 28 are spaced from each other and cooperatively define a substantially cylindrical cavity 36 for receiving the rotor 30. In addition, a positioning groove 46 is forming in an inner surface of each pole shoe, which extends along an axial direction of the motor. Preferably, the positioning groove 46 is formed at a center position of each first pole shoe 26 or second pole shoe 28. The motor configured as such is suitable for bidirectional startup. That is, the rotor 30 is capable of being rotated clockwise or anti-clockwise.

The rotor 30 includes a rotary shaft 31, and a rotor main body fixedly attached around the rotary shaft 31. The rotor main body includes a plurality of permanent magnet poles formed by a permanent magnet 35. Preferably, the rotor main body includes a rotor core 33 fixedly attached around the rotary shaft 31 and a permanent magnet 35 mounted to the rotor core. The permanent magnet 35 is preferably annular in shape. Preferably, an air gap with even thickness is formed between an outer circumferential surface of the permanent magnet 35, and the first pole shoe 26 and the second pole shoe 28. That is, major portions of arc inner surfaces of the first, second pole shoes 26, 28 are located on a cylindrical surface centered at a center of the rotor, except for the areas of the positioning grooves 46. In this embodiment, each first pole shoe 26 and one adjacent second pole shoe 28 define there between a slot opening 47 with large magnetic reluctance. Alternatively, the slot opening 47 may be replaced by a magnetic bridge. The positioning grooves 46 are provided to enable a pole axis of a permanent magnet pole of the rotor when stopping to be offset from a pole axis of a corresponding stator pole by an angle, such that an initial position of the rotor 30 deviates from a dead point position. As a result, when the stator winding 23 is energized, the rotor 30 can be started in a predetermined direction to avoid the startup failure.

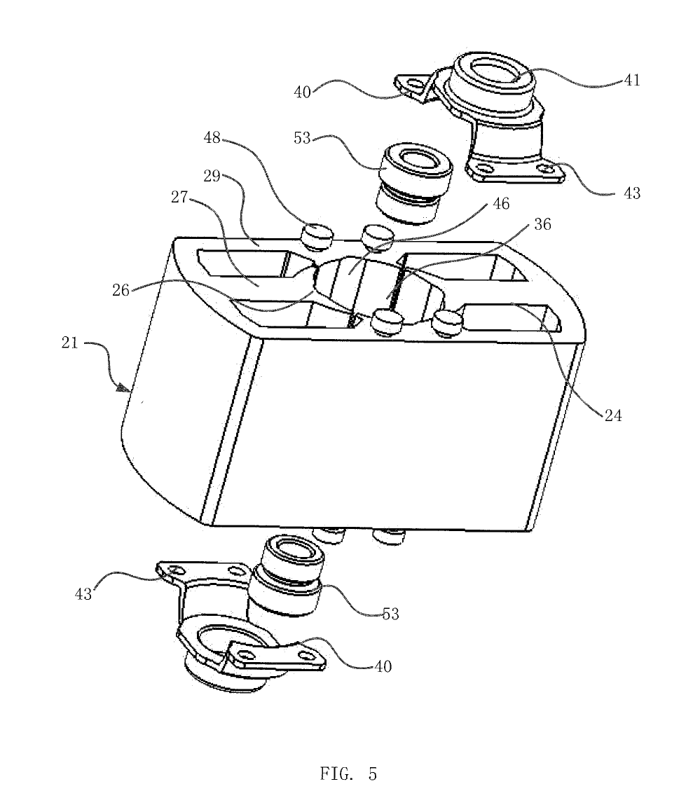

Referring to FIG. 2 and FIG. 5, two end caps 40 are respectively mounted to two opposite ends of the stator core 21. A bearing 53 is mounted in each end cap 40. The rotary shaft 31 is mounted to the stator core 21 via the two bearings 53. In particular, each end cap 40 includes a first hub 41 forming a bearing seat for mounting of the bearing 53. In this embodiment, one of the end caps 40 is mounted across and axially above the two second pole shoes 28, and the other end cap 40 is mounted across and axially below the two second pole shoes 28. Portions of the end cap 40 in contact with an axial end face of the second salient poles 25 define through holes 43. Connecting members such as bolts 48 pass axially through the through holes 43 of the two end caps 40 and the stator core 21, thereby fixing the two end caps 40 to the two axial ends of the stator core 21, respectively. In practice, the stator core 21 may be formed by stacking a plurality of stator core laminations, each defining through holes 58 for allowing the connecting members 48 to pass therethrough.

As shown in FIG. 2, a worm 91 is disposed at an output end of the rotary shaft 31, which engages with a worm gear 97 in the gearbox 90. The rotary shaft 31 is rotatably mounted to the housing 105 through the two first bearings 93 at two ends of the worm 91, respectively. The two first bearings 93 are in rigid connection with the housing 105. Therefore, the two first bearings 93 determine the orientation of the rotary shaft 31. It should be understood that the worm 91 may be attached around the rotary shaft 31 or directly formed on the rotary shaft 31.

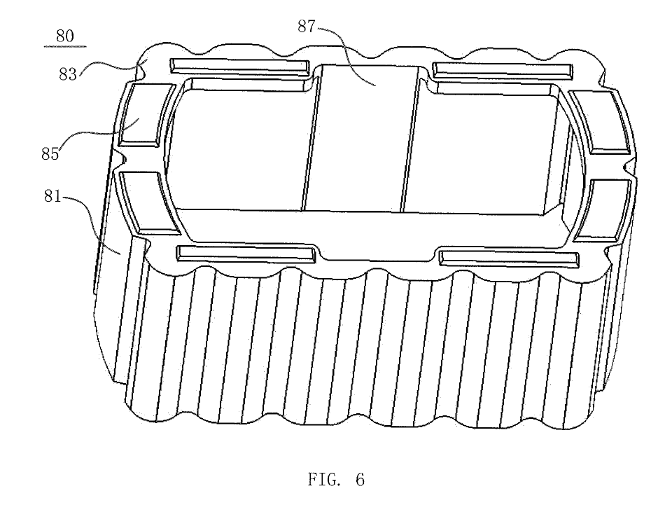

In addition, on the basis that the two bearings 93 determine the orientation of the rotary shaft 31, a soft end cap structure is used between the housing 105 and the motor 10 in order to reduce or avoid over-constraint to the rotary shaft 31 imposed by other bearings 53. In particular, as shown in FIG. 6, a resilient member 80 is disposed between the motor 10 and the housing 105, which forms the soft end cap structure between the housing 105 and the motor 10 and absorbs vibrations of the motor. As a result, the motor 10 and the housing 105 are not in rigid connection with each other, such that the bearings 53 in the interior of the motor do not impose an over-constraint to the rotary shaft 31, and the orientation of the rotary shaft 31 is determined by the two bearings 93 mounted to the housing 105. Similar to a cantilever structure, the motor stator and rotor as a whole are suspended/supported at one end of the rotary shaft and therefore can swing with small amplitude relative to the housing 105. In this embodiment, the resilient member 80 is made of rubber, which wraps around an outer circumferential surface of the stator core 21. In assembly, the resilient member 80 is sandwiched between the stator core 21 and the housing 105.

In traditional single phase motor where the stator 20 is rigidly fixed to the housing 105, when the motor stops the cogging torque of the motor may be possibly unable to overcome an external force such as friction forces between shaft and bearings and resistance force from the gear 97, and the motor rotor may stop at positions close to the dead point position (where the magnetic pole of the motor rotor is aligned with the stator tooth/pole), thereby causing the failure of a next startup. In this embodiment of the present invention, the motor may swing relative to the housing 105. Therefore, even the motor rotary shaft is stuck at positions close to the dead point position, during the period of motor startup, the motor stator 20 may swing relative to the rotor along a circumferential direction of the rotary shaft under the action of the electromagnetic force, thereby further deviating the motor rotor from the dead point position and hence avoiding the startup failure.

As shown in FIG. 6, the resilient member 80 preferably includes a first portion 81 for wrapping an outer side surface of the stator core 21 and a second portion 83 for covering one axial end face of the stator core 21. The first portion 81 directly contacts the housing 105, and the second portion 83 is sandwiched between the axial end face of the stator core and the housing. Preferably, an outer surface of the first portion 81 of the resilient member 80 is wave-shaped or formed with a grooved structure, and the second portion 83 is formed with a plurality of protrusions 85, which give the resilient member more room for deformation. In this embodiment, the area of the inner surface of the second portion 83 facing the second pole shoe 28 forms a recess 87 for avoidance of the end caps 40.

In this embodiment, the rotary shaft 31 and the rotor main body are in fixed/rigid connection such that they are capable of synchronous rotation. The stator of FIG. 4 includes two windings 25 wound around the winding portions 27 of the first salient poles 24, respectively. As the motor operates, the stator and the rotor each form four magnetic poles. The motor may be called as a four-pole motor. It should be understood that, in other embodiments, the stator and the rotor may each have another number of the magnetic poles, such as two or six. The motor 10 of the present invention is preferably a single phase permanent magnet brushless direct current (BLDC) motor.

The present invention further provides a vehicle window lifter which includes the driving device 100 in any of the above embodiments.

In the driving device and the vehicle window lifter using the driving device, over-constraint to the rotary shaft can be avoided by reducing the number of the rigid end cap points between the rotary shaft and the housing. In addition, the motor uses the cantilever end cap structure and, therefore, can swing relative to the housing of the gearbox. As such, even if the motor rotary shaft is stuck at the dead point position, at motor startup, the motor stator may swing relative to the rotor along a circumferential direction of the rotary shaft under the action of the electromagnetic force, thereby deviating the motor rotor from the dead point position and hence avoiding the startup failure. The resilient member between the motor and the housing can block the vibrations of the motor from being conducted to the housing.

It should be understood that the rotary shaft of the motor may be of an integral type, i.e. formed by a single section. Alternatively, the rotor shaft may be segmented, with segments connected by shaft couplings.

The preferred embodiments of the present invention have been described with reference to the drawings. Various modifications may be made without departing from the spirit and scope of the present invention. For example, some features shown or described in one embodiment may be applied to another embodiment to obtain a further embodiment. The above descriptions are merely the preferred embodiments of the present invention and shall not be used to limit the scope of the present invention. Any equivalents made in accordance with the disclosure of the specification and drawings shall also fall within the scope of the present invention.

1. A driving device comprising:
a motor comprising a stator and a rotor rotatably disposed in the stator, the rotor comprising a rotary shaft; and
a gearbox driven by the motor, the gearbox comprising a housing in which the motor is mounted, and a gear mounted to the housing and driven by the rotary shaft of the motor, two first bearings mounted in the housing at the same side of the stator for supporting the rotary shaft and allowing the stator to swing relative to the housing.

2. The driving device of claim 1, wherein a portion of the rotary shaft extending into the gearbox is mounted/formed with a worm, and the worm is disposed between the two first bearings.

3. The driving device of claim 1, wherein the housing supports the motor through a soft support structure.

4. The driving device of claim 3, wherein the soft support structure includes a resilient member sandwiched between an outer circumferential surface of stator of the motor and the housing.

5. The driving device of claim 4, wherein an outer surface of the resilient member for contacting the housing is wave-shaped or formed with a grooved structure.

6. The driving device of claim 3, wherein two end caps are mounted respectively to two ends of the stator, each of the end caps is mounted with a second bearing, the rotor includes the rotary shaft and a rotor main body fixed to the rotary shaft, and the rotary shaft is rotatably mounted to the stator through the second bearings.

7. The driving device of claim 6, wherein the stator comprises a stator core, the two end caps are mounted respectively to two axial ends of the stator core, and the soft support structure is a resilient member wrapping around an outer circumferential surface of the stator core.

8. The driving device of claim 7, wherein the resilient member wraps around the outer circumferential surface and at least a part of an axial end face of the stator core.

9. The driving device of claim 8, wherein a portion of the resilient member for wrapping around the axial end face of the stator core is formed with a plurality of protrusions.

10. The driving device of claim 7, wherein the motor further comprises a connecting member that passes through the two end caps and the stator core along an axial direction of the motor.

11. The driving device of claim 7, wherein the stator core comprises a ring-shaped yoke, two first salient poles extending inwardly respectively from two opposed first inner surfaces of the yoke, and two second salient poles extending inwardly respectively from two opposed second inner surfaces of the yoke, each first salient pole includes a winding portion for mounting of a stator winding, and no winding is wound around the second salient poles.

12. The driving device of claim 11, wherein a first pole shoe extends from an inner end of each first salient pole toward two circumferential sides thereof, each second salient pole comprises a second pole shoe extending along circumferential directions of the rotor, and the first pole shoes and the second pole shoes are spaced from each other and cooperatively define a substantially cylindrical cavity for receiving the rotor.

13. The driving device of claim 12, wherein a positioning groove is formed at a circumferential center of an inner surface of each of the first pole shoes and second pole shoes.

14. The driving device of claim 1, wherein the motor is a single phase permanent magnet brushless motor.

15. The driving device of claim 1, wherein the two first bearings are located at the same axial side of the motor such that the motor is suspended at one end of the rotary shaft and is therefore capable of slightly swinging relative to the housing.

16. A vehicle window lifter comprises a driving device, the driving device comprising:
a motor comprising a stator and a rotor rotatable relative to the stator, the rotor comprising a rotary shaft; and
a gearbox driven by the motor, the gearbox including a housing in which the motor is mounted, and a gear mounted to the housing and driven by the rotary shaft of the motor, the rotary shaft being supported by the housing via two bearings which are located at the same axial side of the stator of the motor such that the motor is suspended at one end of the rotary shaft and the stator is therefore capable of slightly swinging relative to the housing.

17. The vehicle window lifter of claim 16, wherein the motor is a single phase permanent magnet brushless motor.

18. The vehicle window lifter of claim 17, wherein the motor is a four-pole motor with only two windings.
